(19) United States
(12) Patent Application Publication
(10) Pub. No.: US 2016/0316968 A1
(43) Pub. Date: Nov. 3, 2016

(54) Cooking Container Provided with a Temperature Sensor and Means for Identifying a Cooking Area

(71) Applicant: SEB S.A., Ecully (FR)

(72) Inventor: Benoît Linglin, Saint Martin Bellevue (FR)

(21) Appl. No.: 15/101,151

(22) PCT Filed: Dec. 2, 2014
(86) PCT No.: PCT/FR2014/053129

§ 371 Date: Jun. 2, 2016

(30) Foreign Application Priority Data
Dec. 5, 2013 (FR) 1362201

(51) Int. Cl. A47J 37/10; A47J 36/00

(52) U.S. Cl. CPC A47J 37/108; A47J 36/00

(57) ABSTRACT

Provided is a cooking container (1, 1′) including a bottom (3, 3′) having a temperature sensor (10) which is electrically connected to signal processing and display means (40) arranged at a distance from said temperature sensor (10). The bottom (3, 3′) of the cooking container includes means (20a, 20b, 20e, 20d) for identifying an area for placing the food to be cooked, said area being arranged facing the temperature sensor (10) in order to allow the user to monitor the cooking temperature of said food.

This invention pertains to a cooking container designed to cook food, particularly a frying pan, saucepan, sauté pan, stockpot or pressure cooker, comprising a temperature sensor making it possible to measure the cooking temperature.

In document EP0931495 there already exists a cooking container comprising a bottom and a side wall, and a temperature sensor built into the bottom and connected to an electronic circuit to process the magnitude measured by the sensor and display the temperature. Thus, the user can monitor the temperature of the bottom while cooking food.

However, the user can place food to be cooked in the container that occupies only a portion of the bottom. When this food is set down, if the container has been preheated, the temperature drops more significantly in this part than in the rest of the bottom where no food is placed. Thus, if the temperature sensor is not situated in the portion of the bottom where the food being cooked is placed, the displayed temperature does not correspond to the actual temperature to which the food being cooked is exposed.

Moreover, the temperature of the bottom is not homogenous, which is essentially due to the heating means used and to the construction of the cooking container. The applicant has shown that the maximum temperature difference in the bottom of a cooking container preheated to about 250° C. could be up to 60° C. Thus, the difference between the displayed temperature and the actual temperature to which the food being cooked is exposed may be even greater.

The purpose of this invention is to remedy the disadvantages mentioned above and to offer a cooking container provided with a temperature sensor that makes it possible to ensure the results of cooking a food.

Another purpose of the invention is to offer a cooking container provided with a temperature sensor that is simple in design and inexpensive to implement.

These purposes are fulfilled with a cooking container comprising a bottom provided with a temperature sensor that is connected electrically to an offset signal processing and display means, characterized in that the bottom of the cooking container comprises a means of identifying an area for placing the food to be cooked, said area being arranged facing the temperature sensor in order to allow the user to monitor the cooking temperature of said food.

The phrase “area being arranged facing the temperature sensor” means that the area is arranged flush with the active measurement part of the temperature sensor when the cooking container is resting on a heating means.

The user can easily place the food to be cooked in the identified area, which is arranged flush with the temperature sensor. Thus, the temperature sensor is very close to the food being cooked and the information displayed on the offset display means accurately reflects the temperature change of the food. Consequently, it is not difficult for the user to cook the food successfully by monitoring the information displayed on the offset display means.

Preferably, the identification means comprises a marking.

This arrangement makes it possible to obtain a placement area for the food to be cooked that is clearly visible to the user.

Advantageously, the marking forms a shape comprising a center, said center being flush with the temperature sensor.

Thus, the food placed on the marking is centered on the temperature sensor.

Advantageously, the marking comprises at least one colored surface.

The term “colored surface” means that the color of the marking is different from the color of the bottom. Advantageously, the color is preferably chosen to contrast significantly with the bottom color. Thus, it is very easy for the user to identify the area in which to place the food to be cooked.

Advantageously, the marking comprises at least one line.

Advantageously, the line forms the perimeter of a circle.

Advantageously, the marking comprises at least one letter.

This arrangement makes it possible to obtain a marking comprising a word to help the user understand the particular cooking monitoring function arranged in the cooking container.

Advantageously, the marking comprises at least one pictogram.

The term “pictogram” means a schematic graphical representation, a stylized abstract drawing that functions as a symbol. Thus a marking comprising a pictogram also makes it possible to help the user understand the particular cooking monitoring function arranged in the cooking container. Furthermore, using a pictogram makes it possible to sell the same cooking container in markets where different languages are spoken.

Preferably, the marking is made by an ink deposit process, particularly serigraphy or tampography.

This arrangement makes it possible to obtain a marking using an inexpensive process, which can be easily included in the automated production process of a cooking container. In addition, because the ink deposit is very thin, the bottom of the cooking container bearing the marking has a flat, smooth surface.

Advantageously, the temperature sensor is arranged in the center of the bottom, and the means of identification is consequently arranged in the center of the bottom.

This arrangement allows for an intuitive use of the cooking monitoring function arranged in the cooking container, as the user naturally places the food to be cooked in the center of the bottom.

Preferably, the temperature sensor is arranged in an offset manner with respect to the center of the bottom, and the means of identification is consequently arranged in an offset manner with respect to the center of the bottom.

The applicant has shown that it was economically advantageous to make a single sensor subunit, or even a handle subunit provided with the temperature sensor for a product line of cooking containers, for example, with increasing diameters. The subunit comprises a fixed distance between the temperature sensor and the end of the handle that is attached to the side wall of the cooking container. Thus, for a portion of the cooking containers for which the radius differs from the distance (d), the means of identification is arranged in an offset manner with respect to the center of the bottom. Consequently, the user can place his food to be cooked in an offset manner from the center of the bottom, in order to be flush with the temperature sensor for these cooking containers.

Preferably, the cooking container is a frying pan, saucepan, sauté pan, stockpot or pressure cooker.

The invention will be better understood upon review of the methods of implementation, presented in a non-limiting manner, which are illustrated in the attached figures, in which:

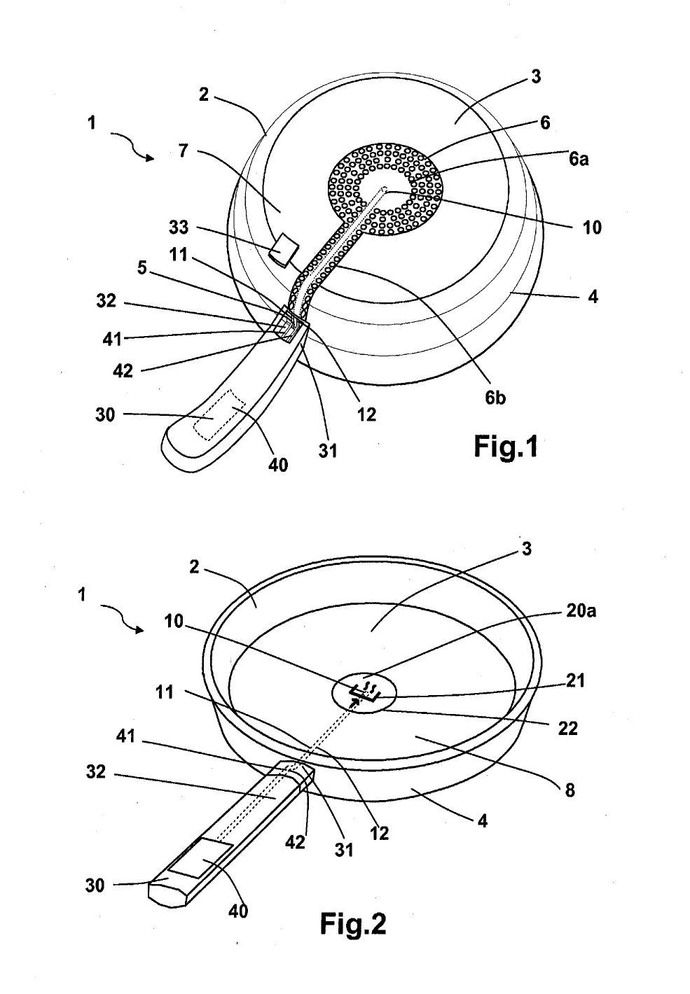

FIG. 1 presents a perspective view from below of a cooking container as described in one particular method of implementing the invention.

FIG. 2 presents a perspective view from above of the cooking container depicted in FIG. 1.

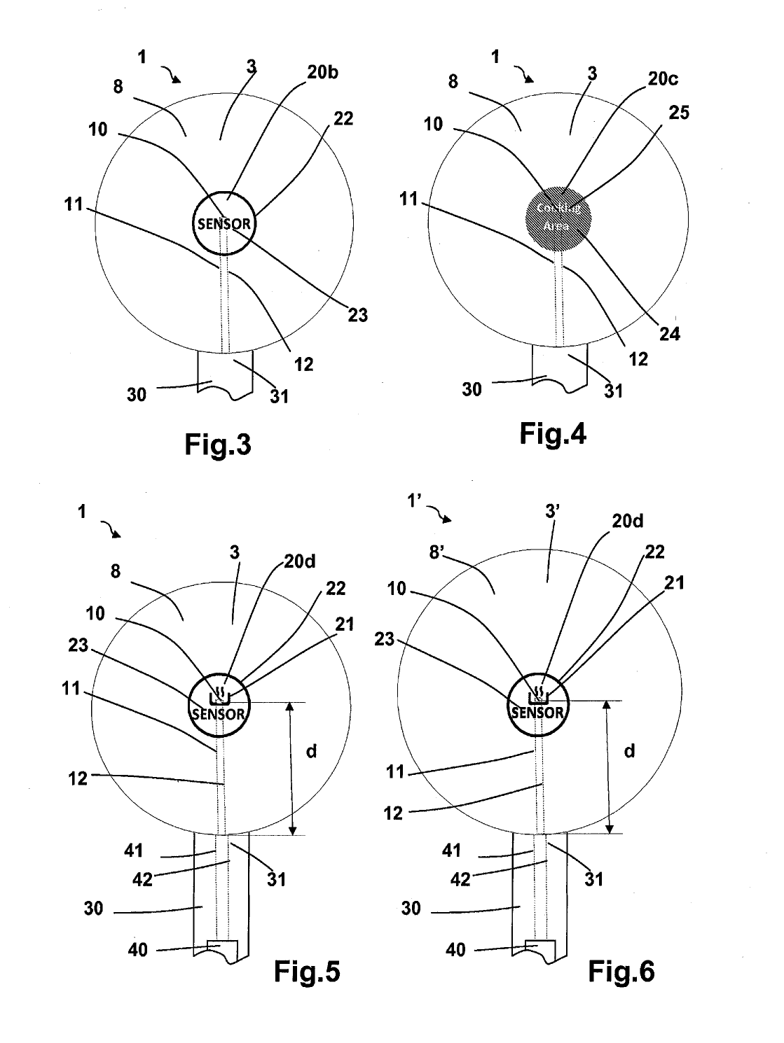

FIG. 3 presents a schematic view from above of the bottom of the cooking container depicted in FIG. 2, the marking being made according to one particular method of implementing the invention.

FIG. 4 presents a schematic view from above of the bottom of the cooking container depicted in FIG. 2, the marking being made according to another particular method of implementing the invention.

FIG. 5 presents a schematic view from above of the bottom of the cooking container depicted in FIG. 2, the marking being made according to another particular method of implementing the invention.

FIG. 6 presents a schematic view from above of the bottom of a cooking container from the same product line as the cooking container depicted in FIG. 5, but with a larger diameter.

In one method of implementation shown in FIG. 1, a cooking container (1) comprises a bowl (2) with a bottom (3) and a side wall (4). The cooking container (1) comprises a perforated plate (6) attached to one exterior surface (7) of the bowl (2) and a temperature sensor (10) arranged between the exterior surface (7) of the bowl (2) and the perforated plate (6). The temperature sensor (10) may comprise, in particular, an active part formed by a Negative Temperature Coefficient thermistor or a thermocouple. The temperature sensor (10) is provided with two conductive elements (11, 12), which are connected electrically to a signal processing and display means formed by an electronic circuit (40) to process the magnitude measured by the temperature sensor (10) and display the temperature or information pertaining to the temperature. The temperature sensor (10) extends radially from the center of the bottom (3) toward the side wall (4). The perforated plate (6) comprises a circular part (6a) that covers the temperature sensor (10) and a central part of the exterior surface of the bottom (3); and an elongated part (6b) that covers the conductive elements (11, 12) and extends radially on the exterior surface of the bottom (3), as well as partially on the exterior surface of the side wall (4).

The bowl (2) of the cooking container is made of an aluminum disc that is between 2 and 6 millimeters thick, the disc comprising a groove (5). The perforated plate (6) provided with the temperature sensor (10) and conductive elements (11, 12) is positioned on the disc in such a way that the temperature sensor (10) is positioned in the groove (5), and then the perforated plate (6) is attached to the disc by a stamping operation. To understand the process of attaching the perforated plate (6) to the disc (2a), please refer to the descriptions in French patent numbers FR2693894 and FR2711051 filed by the applicant. The disc thus provided with the perforated grill (6) and the temperature sensor (10) is formed by a stamping operation to create the bowl (2) of the cooking container (1).

As depicted in FIGS. 1 and 2, the cooking container (1) comprises a handle (30), one end (31) of which is attached to the side wall (4) by an attachment means (not depicted in the figures). The electronic circuit (40) is arranged in the handle (30) and is connected electrically to the conductive elements (11, 12) by two terminals (41, 42). The end (31) of the handle (30) comprises a housing (32) in which the conductive elements (11, 12) are connected to the terminals (41, 42), for example, by soldering. The housing (32) is closed by a cap (33) (depicted in an “exploded view” manner in FIG. 1).

As shown in FIG. 2, the cooking container (1) comprises an interior surface (8) that has a marking (20a), which is arranged flush with the temperature sensor (10). The marking (20a) forms a means of identifying an area for placing the food to be cooked in the cooking container (1). The marking (20a) comprises a pictogram (21) that depicts, in a symbolic manner, a heated cooking container and an arrow indicating the placement area. The marking (20a) also comprises a line (22) forming the perimeter of a circle. The circle comprises a center arranged flush with the temperature sensor (10). In this method of implementation where the temperature sensor (10) is arranged in the center of the bottom (3), the marking (20a) is also positioned in the center of the bottom (3).

FIG. 3 presents a schematic view from above of the bottom (3) of the cooking container (1). The bottom (3) comprises a marking (20b) in one other particular method of implementing the invention. The marking (20b) comprises several letters (23) forming the word SENSOR to indicate to the user the presence of the temperature sensor (10). In the same manner as for the marking labeled 20a, the marking labeled 20b also comprises a line (22) forming the perimeter of a circle.

FIG. 4 also presents a schematic view from above of the bottom (3) of the cooking container (1). The bottom (3) comprises a marking (20c) in one other particular method of implementing the invention. The marking (20c) comprises a colored surface (24) in the form of a circle. The colored surface (24) comprises non-printed areas in the form of letters (25) to show the words “Cooking” and “Area” thereby indicating to the user the area in which to place the food to be cooked.

As shown in FIG. 5, the bottom (3) of the cooking container (1) comprises a marking (20d) in one other particular method of implementing the invention. The marking (20d) comprises a pictogram (21), several letters (23) forming the word SENSOR and a line (22) forming the perimeter of a circle.

The temperature sensor (10) provided with conductive elements (11, 12), potentially placed inside a tubular sheath, form a sensor subunit. The temperature sensor (10) is arranged at a first end of the sensor subunit. A second end of the sensor subunit forms a connection area between the conductive elements (11, 12) and the terminals (41, 42) of the electronic circuit (40), the connection area being arranged at the end (31) of the handle (30). The sensor subunit is the same for a product line of cooking containers with different diameters. Thus, the distance (d) from the temperature sensor (10) to the connection area is the same for all of the containers in the product line.

The cooking container (1) of the product line comprises a marking (20d) that is centered on the bottom (3), flush with the temperature sensor, which is also arranged in the center of the bottom (3). The distance (d) is roughly equal to the radius of the bottom (3).

As depicted in FIG. 6, a cooking container (1′) from the same product line as the cooking container labeled 1, has a bottom (3′) diameter that is greater than the bottom labeled 3. The bottom (3′) comprises the marking (20d) arranged on an interior surface (8′). The cooking container (1′) comprises the same sensor subunit as the cooking container labeled 1. The temperature sensor (10) is arranged at a distance (d) from the connection area, situated at the end (31) of the handle (30). Thus, the marking (20d), which is flush with the temperature sensor (10), is offset toward the handle.

During operation, the user places the cooking container (1) on the heating means and preheats the bowl (2) to a temperature that the user can monitor on the signal processing and display means formed by the electronic circuit (40). Once the preheating temperature is reached, the user places the food to be cooked on the marking (20a) situated in the center of the bottom (3) and flush with the temperature sensor (10). The user can then monitor the cooking of the food by watching the information provided by the electronic circuit (40) connected to the temperature sensor (10) situated as close as possible to the food, and the electronic circuit (40) may comprise an audible alarm to alert the user when the set temperature is exceeded.

If the user is using the cooking container labeled 1′, once the preheating temperature is reached, the user places the food to be cooked on the marking (20d) situated in an offset manner with respect to the center of the bottom (3′) and flush with the temperature sensor (10).

Of course, the invention is in no way limited to the methods of implementation described and depicted, which have been provided only as examples. Modifications remain possible, particularly with regard to the makeup of the various components or by substituting equivalent techniques, while still remaining within the scope of protection of the invention.

Thus, in one variation of implementation, the marking may comprise parts that are indented or in relief. These parts that are indented or in relief are preferably made by stamping the bottom at the time the cooking container is formed.

In another variation of implementation, the means of identifying an area in which to place the food to be cooked comprises a device that emits a beam of light that can, advantageously, be arranged on the handle. The beam of light is directed toward the bottom of the cooking container to form an illuminated area that is flush with the temperature sensor and that defines the area in which to place the food to be cooked.

1. Cooking container comprising a bottom provided with a temperature sensor connected electrically to a signal processing and display means offset from said temperature sensor, wherein the bottom of the cooking container comprises a means of identifying an area for placing the food to be cooked, said area being arranged facing the temperature sensor in order to allow the user to monitor the cooking temperature of said food.

2. Cooking container as described in claim 1, wherein the means of identification comprises a marking.

3. Cooking container as described in claim 2, wherein the marking forms a shape comprising a center, said center being flush with the temperature sensor.

4. Cooking container as described in claim 2, wherein the marking comprises at least one colored surface.

5. Cooking container as described in claim 2, wherein the marking comprises at least one line.

6. Cooking container as described in claim 5, wherein the line forms a perimeter of a circle.

7. Cooking container as described in claim 2, wherein the marking comprises at least one letter.

8. Cooking container as described in claim 2, herein the marking comprises at least one pictogram.

9. Cooking container as described in claim 2, wherein the marking is made by an ink deposit process, selected from one of serigraphy or tampography.

10. Cooking container as described in claim 1, wherein the temperature sensor is arranged in the center of the bottom and the means of identification is arranged in the center of the bottom.

11. Cooking container as described in claim 1, wherein the temperature sensor is arranged in an offset manner with respect to the center of the bottom and the means of identification is arranged in an offset manner with respect to the center of the bottom.

12. Cooking container as described in claim 1, wherein the cooking container is a frying pan, saucepan, sauté pan, stockpot or pressure cooker.
